(19) United States
(12) Patent Application Publication
(10) Pub. No.: US 2008/0107958 A1
(43) Pub. Date: May 8, 2008

(54) Chargeable Electrochemical Cell

(75) Inventor: Vladimir KLIATZKIN, Kiriat Yam (IL)

Correspondence Address: BRUCE E. LILLING;LILLING & LILLING PLLC, P.O. BOX 560, GOLDEN BRIDGE, NY, 10526, US

(73) Assignee: Unibatt Ltd., Kiryat Yam (IL)

(21) Appl. No.: 11/850,324

(22) Filed: Sep. 5, 2007

Related U.S. Application Data
(63) Continuation-in-part of application No. 10/070,501, filed on Mar. 7, 2002.

(51) Int. Cl. H01M 2/14; H01M 10/36

(52) U.S. Cl. 429/129

(57) ABSTRACT

A rechargeable electrochemical cell, made out of electrodes, which differ in the active material, installed in a canister. The electrodes are made of an expanded or woven metal mesh or foil substrate coated with pressed, not sintered nor resin bonded active material powder. One kind of the electrodes are wrapped in separators made of an insulating membrane, permeable to the ions of a suitable electrolyte. In order to ensure close contact, as needed, between the powder particles and the electrode substrate, during charging and discharging, the electrodes are installed in the can of the battery, which is providing the needed pressure distribution on the external surface. The can provides the counter pressure to the swelling of the active material and maintains the pressure despite the volume changes during the reaction. Some time in order to apply the needed pressure on the electrodes, other means can be utilized, as for instance an elastic rubber layer between the electrodes and can.

### BACKGROUND OF THE INVENTION

1. Field of the Invention

This invention relates to rechargeable electrochemical accumulators, otherwise known as rechargeable batteries. In order to improve the performance of the rechargeable batteries, the layout of the active material used and the structure of the battery have been improved in order to permit realization of deep charge-discharge cycles up to twice the depth of any existing accumulator. By utilizing powdered electrodes that are not sintered or glued, higher realized capacity of the accumulator and an enlarged number of life cycles are achieved. The invention is suitable for accumulators, where volume weight and cost are important factors.

2. Summary of the Prior Art

The problem of the accumulators made out of heavy metal electrodes such as Lead, Silver, etc is high specific weight and as a result higher costs and lower compact ability. Electrodes that are made out of these metals have low structural mechanical strength. To compensate for the low mechanical strength of the electrode structure, the particles of electrodes are being sintered, glued or strengthened by other mechanical means. Because of this process, much of the effective surface is being sacrificed to the bonding and gluing. In order to reach the same capacity more active-material is needed, thus larger electrode structure, to get the same active surface and therefore the cell weight increases. Another problem arising from this process is the inability to dissolve and disconnect the granules from the electrode during the discharge process without jeopardizing the structure of the electrodes. This issue is limiting the discharge depth of the battery, the outcome of which is the limitation and reduction of the capacity.

Electrodes made out of powder not bonded nor sintered, have high active surface areas 1.5-2 (m²/g). It is well known that electrodes made out of powder, in other words the electrode have not been sintered, glued, resin bonded or otherwise mechanically or chemically bonded, this have great specific surface area and there for it is possible to achieve high specific power, which gives them the advantage of having high capacity at the same rate of discharge.

In addition, some electrochemical systems, such as Zinc-Silver, have experienced dendrite problems. Dendrites are electrode growths that induce short circuits and as a result limit the number of life cycles of the rechargeable electrochemical cell.

For the purposes of this application rigid cell walls is defined as walls which when pressure is applied have little or no change in shape. For further clarity, rigid cell walls exhibit little or no bowing in relation to internal cell pressure. Thus, rigid cell walls permit an increase in pressure based on swelling or expansion of materials internal to the cell and a decrease in pressure during contraction of internal materials.

For purposes of this application flexible or spring like cell walls maintain constant or near constant pressure despite the reduction in volume of materials and structures within the cell.

For the purposes of this application pressed electrodes consist of particles which are not sintered glued or otherwise mechanically or chemically bonded, and when inserted in an electrolyte permit the particles of the electrode to move in relation to each other in order to compensate for the volume changes.

Yardney (U.S. Pat. No. 2,812,376) discloses use of a cellophane separator within a cell of rigid dimensions or having a rigid cell wall. As Yardney suggests the problem with cellophane is an increase in dimension when soaked in an electrolyte. Yardney seeks to reduce this swelling of the separator membrane and therefore improve performance by maintaining the distance between the electrodes and as a result the pressure, by applying a pressure inside the rigid cell walls. Yardney applies this pressure by including within the “rigid” cell wall structure a movable wall or partition supported by spring mechanism. It is important to understand that the rigid cell of Yardney contemplates walls that must flex or bow inward or outward considerably less than the movement or the spring mechanism for maintaining pressure. This rigid cell wall feature is important in Yardney as the maintenance of pressure within the rigid cell is accomplished by the spring mechanism, and excessive flexing of the walls of the cell would diminish the effectiveness of the spring mechanism. The layout proposed by Yardney, describes a pressure of 1-1.5 Bars, which in order to be achieved will need twice the volume of the battery.

Honda (U.S. Pat. No. 5,580,676) discloses a battery that includes a plurality of cathode plates and anode plates alternately superposed via a separator to face each other. The cathode or anode plates are formed by coating one or both sides of a plane, substantially rectangular sheet-like aluminum foil with a mixed agent, and then drying and pressing the resulting product. The mixed agent is a mixture of a powder active agent, carbon powder as and PVDF as a binder. The use of PVDF as a binder prevents movement of the particles of the active powder once the plate is formed. The incorporation of the conductive carbon powder further inhibits the movement of the active agent particles and reduces contact between the particles. The battery casing of Honda is formed as a rectangular casing of Fe with Ni plating thereon, having one side open. This indicates a structurally rigid cell wall as is common in the art. Honda seeks to preserve performance by reducing the intrusion of electrode powder by packing the plates with the separators. Honda does not contemplate the use of pressure within the cell to maintain or change performance.

Tsutsue (US 2002/0006548) discloses design for a lightweight polymer electrolyte battery affording a high capacity density in which a layer of electrode active material mixture containing a polymer has an adequately regulated porosity and/or polymer content. The electrodes of the battery contemplated by Tsutsue in are bonded with a porous polymer substrate to maintain the structure of the electrode. Tsutsue contemplates the optimal volume of polymer to active material to maintain adhesion of the particles in the form of plates. Tsutsue discusses the use of electrodes in a unitary bound sheet-like structure and an electrolyte layer as the power-generating element. These properties can give a rechargeable battery consisting of thin flexible laminate sheets even when housed in a jacket case.

### SUMMARY OF THE INVENTION

The object of this invention is to increase the specific energy (Wh/kg) and the energy density (Wh/l) of an electrochemical cell, while, decreasing the volume and weight, by providing for powdered electrodes, which are not sintered, glued or otherwise chemically or mechanically bonded.

It is another object of the present invention to increase the mechanical strength of the structure of the accumulator and prolong the life of it, i.e. enlarge the number of charge/discharge life cycles. This is achieved through a variable volume container that maintains an increased pressure on the electrode particles, which thereby provides the needed contact between the particles.

It is a further object of the present invention to make a more efficient accumulator, by increasing the charge and discharge depth of the rechargeable electrochemical cell this is accomplished by providing greater surface area of the electrodes by not sintering, gluing or otherwise chemically or mechanically bonding the particles of the electrodes.

It is a further object of the present invention to provide electrodes which have a more active material surface, improved conductivity and greater structure stability by providing increased and more consistent pressure on the particles maintaining closer contact, as needed, not just between the particles at the electrode, but between the particles and the substrate of the electrodes.

It is a further object of the present invention to prolong the lifetime, in other words increase the number of life cycles, of the rechargeable electrochemical cell. This is accomplished by providing particulate electrodes under a consistent pressure from a non-rigid case and an electrolyte permeable membranes separating the electrodes.

It is also an object of the present invention to ensure the needed close contact between the powder particles and between the particles and the substrate during charging and discharging of the cell without sintering or gluing of the particles. To achieve this object, the battery cell employs an elastic mechanical means capable of exerting pressure directly on the electrodes to ensure close contact between particles of the active material themselves and at the same time close contact between the particles and the substrate.

The electrodes included within this invention, are made out of a sub straight coated with the pressed active material powder. The powder should not be sintered glued or otherwise bonded. The grains of the active material are preferably in the 5 to 10 micron range, although other sizes can be used. Friable materials have more available active surface, which permit a better use of the chemically active material without weakening the electrode's structure.

Other components of the battery, according to this invention, are the separators encapsulating the electrodes. These separators have an insulating set of membrane layers that is permeable to the ions of the electrolyte. On top of that, the separators system prevents over shaping and whiskers growing, that might result with shortcuts.

The substrates of the electrodes, on which the powder or grains of the active material are pressed, are made out of expanded or woven metal mesh or foil. The exact metal to be used is pendent on the nature of the electrochemical couple of the cell and the environment in which it operates. It is also possible to use conductive fabric that may be coated with suitable metals.

The present invention provides a means for applying pressure to the external surface of the assembled cell, ensuring close contact, as needs, between the powder particles and between the particles and the electrode during charging and discharging. This contact is maintained despite significant volume changes of the active material during the reaction.

### BRIEF DESCRIPTION OF THE SEVERAL VIEWS OF THE DRAWINGS

The invention is described here under, by way of examples only, with reference to the accompanying drawings

FIG. 1: Shows a cross sectional view of a prismatic accumulator according to the present invention including a rubber plate spring.

FIG. 2: Is a perspective view of one of the embodiments of the elastic can-acting as spring of the present invention.

FIG. 3: Is a cross sectional view of a spiral electrode couple according to the present invention.

FIG. 4: Shows the tested discharge curves—Current, Voltage vs. Test time for rechargeable electrochemical cell in the configuration of example #1 electrochemical cell of the present invention.

FIG. 5: Shows the tested discharge curves—Internal Resistance vs. Test time for rechargeable electrochemical cell in the configuration of example #1 electrochemical cell of the present invention.

FIG. 6: shows the formation of dendrites over time of typical rechargeable electrochemical cells.

### DETAILED DESCRIPTION OF THE PRESENT INVENTION

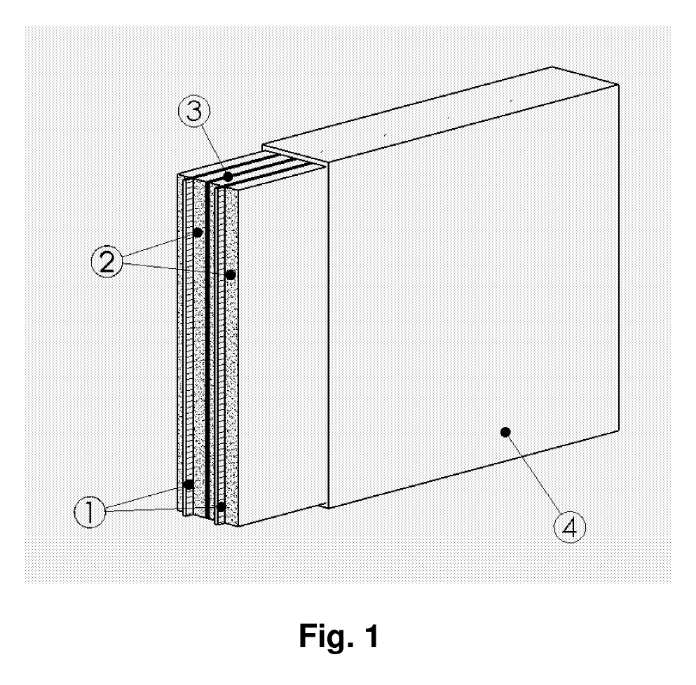

As shown in FIG. 1, the present invention, a rechargeable electrochemical cell, has the following combined elements. A can 4 surrounding the electrodes set that is capable of maintaining pressure within the cell. The can responds to the varying volume of the electrodes during the charge and discharge cycles. The electrodes may be of varying number, but at least one cathode and at least one anode is required. The electrodes are made by compressing active material powder onto a substrate. The resulting porosity should be between 27% and 50%. This porosity allows the diffusion of electrolyte through the powder of the electrodes. The active material powder particles cannot be sintered, glued or otherwise restricted from movement with relation to each other. A separator should be at least between the electrodes but may encapsulate any number of the electrodes. The separator contains at least three kinds of layers where the insulating layer is permeable to the ions of the electrolyte.

1^{st} kinds of layer are made from strength material (woven Nylon) for prevention of over shaping—creep of materials to sides direction.

2^{nd} layers of from swelling diaphragm from prevention of viskers creation in to direction to opposite electrode via limitation of electrolyte delivery in this direction.

3th kinds of electrode have protection role for swelling diaphragm destroyed from atomarized oxygen and from Silver penetration.

FIG. 1 is a cross sectional view of a prismatic system electrochemical accumulator. The can 4 is of a spring like material, such as spring steel. The can 4 must be of a material that flexes to maintain the necessary pressure on the particles 2 of the electrodes without crushing or deforming. An over rigid can material will deform or even crush rigid electrodes.

Prior patents have often utilized some type of spring mechanism housed within the canister to supply an internal pressure. This internal pressure was used to promote movement of the electrolyte between the electrodes and contact of the electrolyte with the electrodes. This is not the object of the can 4 of the present invention. The object of can 4 is to apply pressure to the powder particles 2 of each electrode, in a uniform fashion, approximately on all sides. This pressure is needed where the particles 2 of the electrodes are formed from a powder and are not sintered, glued or otherwise physically held together by a means which could interfere with movement and contact between the powder particles 2 of the electrodes. This needed pressure maintains the shape of the electrode and ensures close contact between the particles 2 of the electrodes. In certain instances, the needed pressure on the electrode particles 2 may be further applied by inserting between the electrodes and the can an elastic rubber layer 3.

The spring quality of the case is important for several reasons. It first ensures close contact between the powder particles 2 of the electrode. It also maintains close contact between the electrode particles 2 and the substrate 1, during charging and discharging. It further minimizes the distance between the electrodes thereby reducing the amount of electrolyte in this region.

Additionally, the canister 4 provides a counter pressure to the swelling of the active material or particles 2 of the electrodes and maintains a constant pressure on the electrodes despite any volume changes that occur within each electrode during the charge and discharge cycles of the cell. This maintains consistent contact between the powder particles of each electrode.

Further, the pressure on the face side of the electrodes serves to limit the supply of the electrolyte to areas where dendrites are most likely to be formed. Particularly, the pressure reduces the volume between the electrodes where dendrites cause shortcuts as shown in FIG. 6.

The pressure maintained on the non-sintered and non-glued electrode particles 2 by the canister 4 allows the particles 2 to move in relation to each other while maintaining close contact. This ability of the particles 2 to move in relation to each other further prevents the formation of dendrites 10 as shown in FIG. 6 on the electrodes 12, which is a common problem with rechargeable cells. The dendrites 10 grow over time during charge and discharge cycles and eventually cause a short circuit between the electrodes 12. By preventing the dendrites 10 from growing the lifetime of the rechargeable battery is substantially increased. Lifetime of electrochemical cells is measured by the number of charge and discharge cycles.

The substrate 1 of the electrodes, on which the powder of the active material 2 are pressed, can be made of expanded metal mesh or foil. The exact metal to be used is dependent on the nature of the electrochemical couple of the cell and the environment in which it operates. It is also possible to use conductive fabric that may be coated with suitable metals, (the exact metal is pendent on the type of the electrochemical couple in the cell and the environment in which the cell operates). For multi-cell versions, non-conductive threads, such as carbon fibers interwoven with fibers of Kevlar, nylon, polyester, etc. may also be used as long as they are coated with suitable metal. It is clear that the carbon fibers must be connected and a conductor lead provided for the current output. Any other combination of the options mentioned above can be used as well as any other suitable substrate known in the art.

The sheet grids may be made from expanded metals, such as silver (for Ag—Zn element). These are manufactured from expanded metal foil relevant to the active material of the cathode or anode. The conductive fabric thickness is generally about 10 to 500 micron.

The fabric can be woven from carbon fibers and coated with a conductive material of suitable metal, the exact metal depending on the nature of the electrochemical couple in the cell and the environment in which the cell operates.

The powder particles of the active material are preferably in the 5 to 10 micron range, although other diameters can be used. By using an electrode made of powder the active surface area of the electrode is increased. The surface area determines the charge depth and rate of the cell. By increasing the surface area there is greater interaction between the electrode and the electrolyte.

In a typical cell, where the electrodes are a solid sheet of sintered, glued or otherwise bonded material, the surface area is obtained by adding the surface area of each face of the electrode.

In order to ensure short circuits do not occur, a separator should be placed between the electrodes. The separator is made of at least three layers.

1^{st} kinds of layer are made from strength material (woven Nylon) for prevention of over shaping-creep of materials to sides direction.

2^{nd} layers of from swelling diaphragm from prevention of viskers creation in to direction to opposite electrode via limitation of electrolyte delivery in this direction.

3th kinds of electrode have protection role for swelling diaphragm destroyed from atomarized oxygen and from Silver penetration.

Due to the thin elements of the electrochemical cells, the weight to power output ratio is improved. Since the main elements of the cells are a conductive fabric, granular active material, suitable membranes and an electrolyte, the cells can withstand extreme accelerations and without detrimental effect on cell performance.

For multi-cell versions, the conductive thread may also be used in combination with non-conductive fibers. In such conductive fabrics, a plurality of parallel carbon fibers interwoven with fibers of Kevlar, nylon, polyester, etc. can be used. The configuration may be one in which each carbon fiber constitutes an electrode. It is clear that the carbon fibers must be connected and a conductor lead provided for the current output.

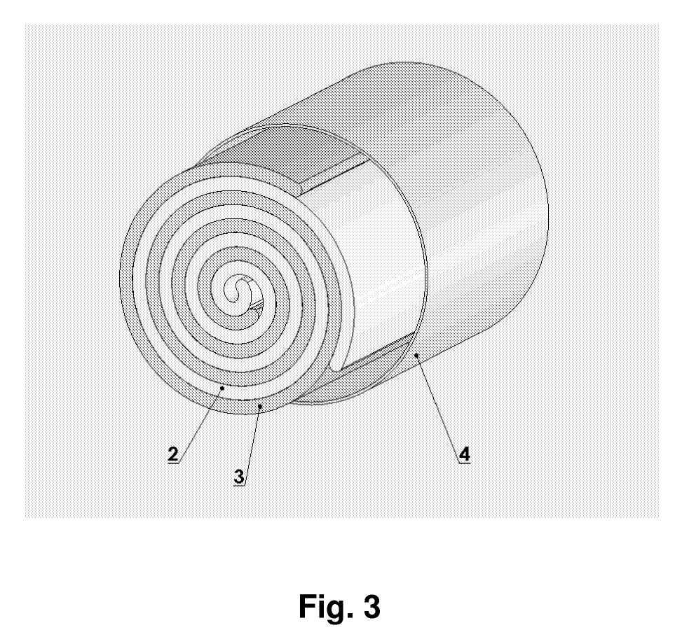

A high energy, high-speed chargeable battery cell can be produced when provided in the helical configuration of FIG. 3.

According to this invention, electrodes, connection elements and cell walls are made from high-strength, conductive or insulative fibers/fabrics, and active material in plate or friable form or the like. Carbon fibers may be used as the conductive part of electrodes while for the insulative parts; nylon, polyester, Kevlar or glass fibers can be used. The exact choice of insulative material also depends on the electrolyte chosen.

Different designs can be used depending on the electrochemical principles. Parts should be designed to obtain stable electrical contact, resulting in conductivity in friable forms of the active material. Similarly, there should be adequate contact between the active material and the substrate.

When the cell has a prismatic shape the can will function as a spring, as mentioned before. Flexible outer cylindrical containers can function as the spring element for cells with helical electrodes. The electrodes can be fabricated in the form of lengthy ribbons, which are then rolled into a spiral configuration. In such a design, it is advantageous to provide spring or spring-like means as mentioned before, to apply pressure on to the external surface of the electrodes and to fabricate the cells in cylindrical form.

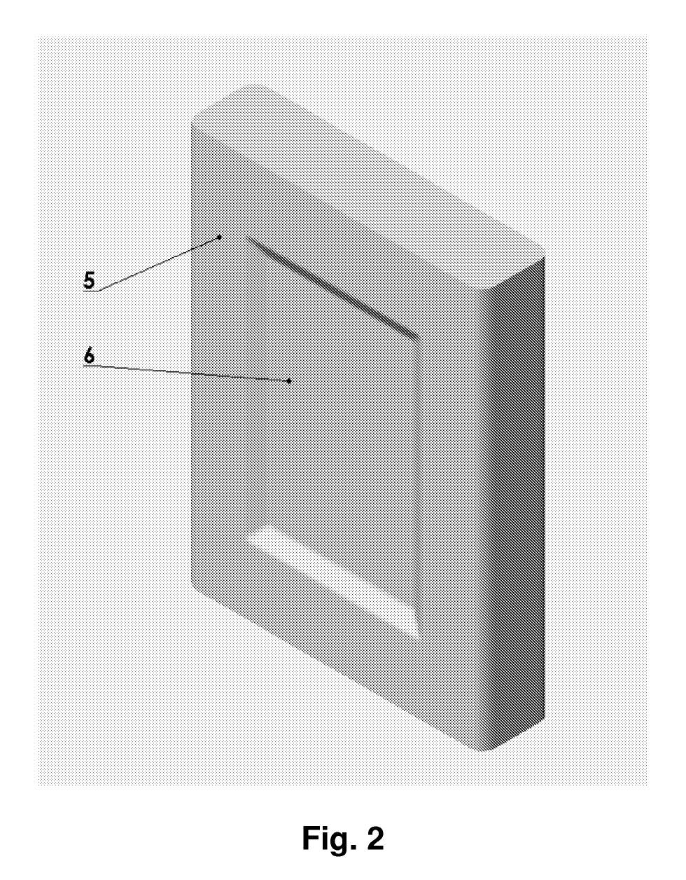

FIG. 2 is a view of the Ag/Zn system can, item 5, acting as springs applying the pressure to the external surface of the assembled cell, perpendicular to the electrodes main surfaces. A deformation 6 may be incorporated in the can walls to strengthen the spring effect being applied on the electrodes and therefore preventing them from swelling.

FIG. 3 shows the cross sectional view of a spiral design for an electrode couple. Items 2 and 3 are the helical rolled form electrodes (made out of pressed powder, not sintered nor resin bonded active material powder). The electrodes are assembled in a coaxial pattern into the elastic cylindrical can (item no. 4) acting as a spring when the anodes and the separators are swelling. As shown, a centerline element 1 such as rubber of a spring should be installed in order to help in applying the pressure as mentioned before. The active area per unit weight in this case is 1875 cm2/g about 1100 times greater than a solid surface.

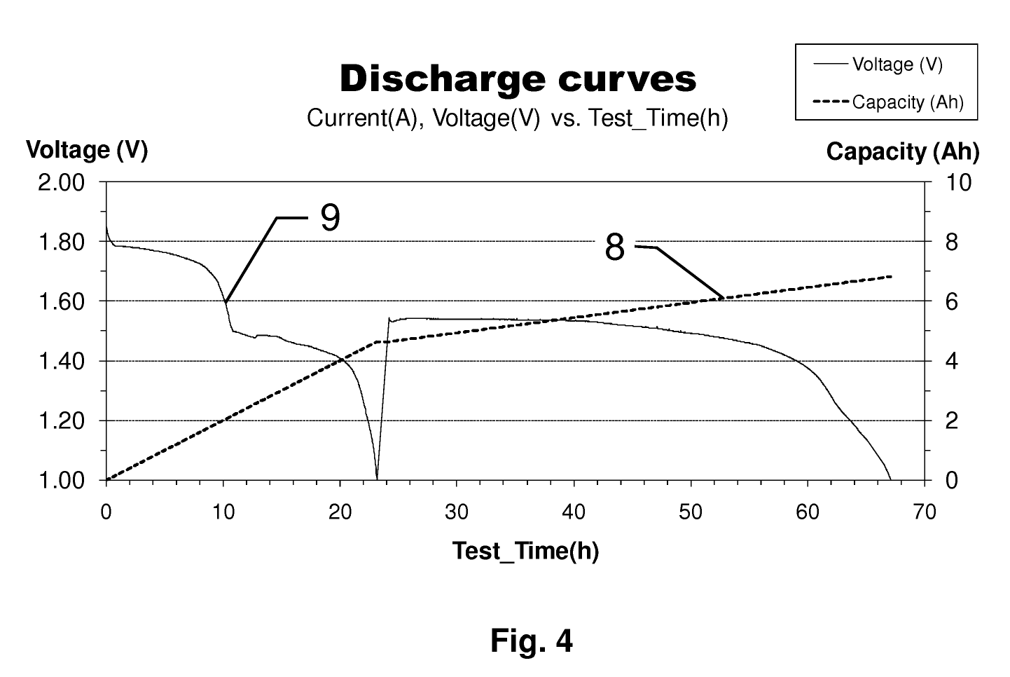

FIG. 4 shows the battery tested discharge curves—Current, Voltage vs. Test time. The specific curve shown is of a battery to be installed in a cell phone with a discharge rate simulating the conversation. The curve 9 represents the capacity of the battery during the discharge process. The capacity nearly reaches the theoretical values of the battery as shown in example no. 1. The 8 curve represents the voltage during the same conditions as mentioned before.

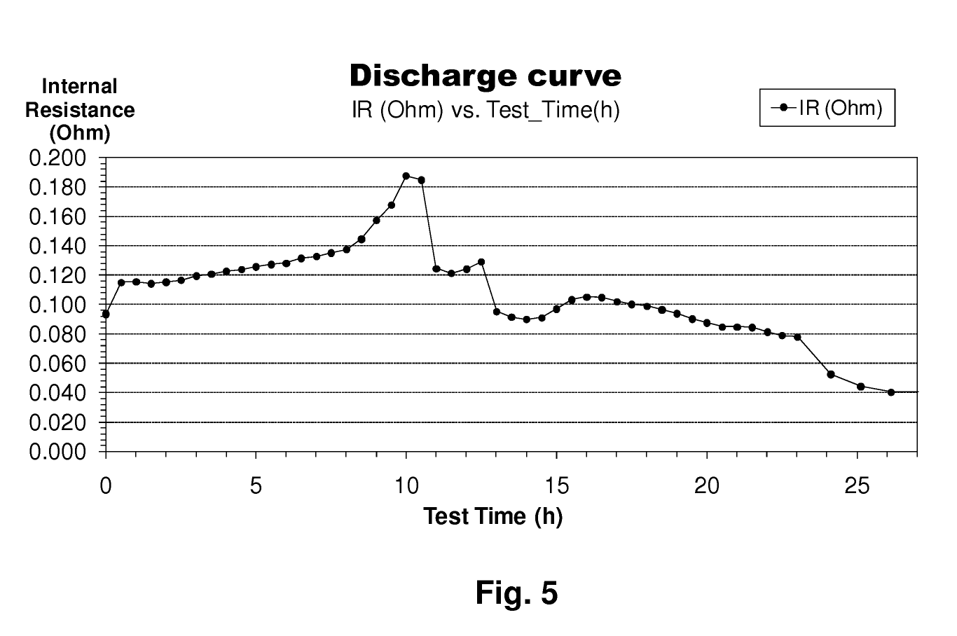

FIG. 5 shows the internal resistance during the discharge process of the same battery as in FIG. 4 and for the same conditions. During most of the process, the internal resistance is about 50 mOhm but for the beginning when the AgO is being converted to Ag₂O at the initial stage. These low values of the internal resistance are being achieved due to the pressure applied by the canister (acting as a spring) on to the electrodes (about 4 bars).

It is the combination of powder electrodes having a can, which acts as a compressing force, with an ion permeable separator membrane that accumulates to achieve the results of the invention.

The following examples, which should not be taken as limiting, the results of which, show life cycle and capacity increases by many orders of magnitude may be achieved.

### EXAMPLES

### Example #1

| Battery layout: | Prismatic | |
|---|---|---|
| Spring system: | Elastic Can | |
| Electrodes Cathode/Anode: | 3/2 | |
| Battery chemical system: | Silver - Zinc | |
| Battery voltage: | 1.5 | Volt |
| Max Battery capacity: | 7.1 | Ah |
| | (Theoretical Value) | |
| Battery capacity (1500 hr): | 5 | Ah |
| Battery 0verall thickness: | 8.1 | mm |
| Battery width: | 34 | mm |
| Battery length: | 47 | mm |
| Silver electrode thickness: | 1.0 | mm |
| Zinc electrode thickness: | 1.0 | mm |
| Silver weight: | 21.75 | g |
| Zinc weight: | 8.6 | g |
| Weight of total active material: | 30.35 | g |
| Weight of electrolyte, KOH: | 6.5 | g |
| Weight of accessories | 12.15 | g |
| Total weight of battery | 49.0 | g |
| Specific weight (max): | 215 | Wh/kg |
| Specific weight (500 hr): | 153 | Wh/kg |
| Energy density (max): | 810 | Wh/l |
| Energy density (500 hr): | 580 | Wh/l |

### Example #2

| Battery layout: | Prismatic | |
|---|---|---|
| Spring system: | Elastic Can | |
| Electrodes Cathode/Anode: | 6/7 | |
| Battery chemical system: | Silver - Zinc | |
| Battery voltage: | 1.5 | Volt |
| Max Battery capacity: | 100 | Ah |
| | (Theoretical Value) | |
| Battery capacity (500 hr): | 70 | Ah |
| Battery 0verall thickness: | 17 | mm |
| Battery width: | 42 | mm |
| Battery length: | 200 | mm |
| Silver electrode thickness: | 1.33 | mm |
| Zinc electrode thickness: | 1.0 | mm |
| Silver weight: | 201 | g |
| Zinc weight: | 147 | g |
| Weight of total active material: | 348 | g |
| Weight of electrolyte, KOH: | 91 | g |
| Weight of accessories | 75 | g |
| Total weight of battery | 537 | g |
| Specific weight (max): | 190 | Wh/kg |
| Specific weight (500 hr): | 130 | Wh/kg |
| Energy density (max): | 1050 | Wh/l |
| Energy density (500 hr): | 740 | Wh/l |

### Example #3

| Battery layout: | prismatic | |
|---|---|---|
| Spring system: | Rubber | |
| Electrodes Cathode/Anode: | 2/1 | |
| Battery chemical system: | Silver - Zinc | |
| Battery voltage: | 1.5 | Volt |
| Max Battery capacity: | 12.3 | Ah |
| | (Theoretical Value) | |
| Battery capacity (500 hr): | 10.4 | Ah |
| Battery thickness: | 3.7 | mm |
| Battery length: | 81 | mm |
| Battery width: | 61 | mm |
| Silver electrode thickness: | 0.93 | mm |
| Zinc electrode thickness: | 0.86 | mm |
| Silver weight: | 44 | g |
| Zinc weight: | 32 | g |
| Weight of total active material: | 76 | g |
| Weight of electrolyte, KOH: | 11 | g |
| Weight of accessories | 12 | g |
| Total weight of battery | 88 | g |
| Specific weight (max): | 215 | Wh/kg |
| Specific weight (500 hr): | 153 | Wh/kg |
| Energy density (max): | 810 | Wh/l |
| Energy density (500 hr): | 580 | Wh/l |

### Example #4

| Battery layout: | cylindrical | |
|---|---|---|
| Spring system: | Elastic Can | |
| Electrodes Cathode/Anode: | 1/1 | |
| Battery chemical system: | Silver - Zinc | |
| Battery voltage: | 1.5 | Volt |
| Max Battery capacity: | 16 | Ah |
| | (Theoretical Value) | |
| Battery capacity (500 hr): | 12 | Ah |
| Battery diameter: | 32 | mm |
| Battery length: | 60 | mm |
| Silver electrode thickness: | 0.8 | mm |
| Zinc electrode thickness: | 0.92 | mm |
| Silver weight: | 32.23 | g |
| Zinc weight: | 24.2 | g |
| Weight of total active material: | 56.43 | g |
| Weight of electrolyte, KOH: | 11.9 | g |
| Weight of accessories | 19.5 | g |
| Total weight of battery | 91.37 | g |
| Specific weight (max): | 263.7 | Wh/kg |
| Specific weight (500 hr): | 200 | Wh/kg |
| Energy density (max): | 500 | Wh/l |
| Energy density (500 hr): | 400 | Wh/l |

Although described with respect to a preferred embodiment of the invention, it should be readily apparent that various changes and/or modifications could be made to the invention without departing from the spirit thereof. All examples are provided for illustration and understanding and are not intended to be limiting. Instead, the invention is only intended to be limited by the scope of the following claims.

1. A rechargeable electrochemical battery cell comprising:
a housing;
at least one pair of electrodes encased in said housing and immersed within an electrolyte, said electrodes including an electrically conductive substrate;
a flexible separator permeable to ions of said electrolyte;
wherein the improvement comprises:
said electrodes comprising non-glued and non-sintered compressed particles of an active material deployed on said substrate where said compressed particles are free to move in relation to each other; and
said housing acting as an elastic means applying pressure on each of said electrodes during charging and discharging of said cell so as to maintain close contact between said particles of each electrode and between said particles and said substrate to counteract periodic changes to the electrode's volume resulting from electrochemical reaction between the electrolyte and the active material taking place during charging and discharging of said cell.
said flexible separator comprising at least two layers.

2. The electrochemical cell of claim 1, wherein said substrate is made of a fabric woven from fibers of a material selected from the group consisting of carbon, synthetic material, nylon and polyester.

3. The electrochemical cell according to claim 2, wherein the thickness of the fabric is between about 10 and 100 microns.

4. The electrochemical cell according to claim 1, wherein the substrate is made of expanded metal grid.

5. The electrochemical cell according to claim 1, where the electrodes are selected from the group consisting of: Ni/Cd, Ag/Zn, Pb/PbO.

6. The electrochemical cell according to claim 1, wherein the thickness of each electrode is between about 0.8 and 10 mm.

7. The electrochemical cell according to claim 1, wherein the particles have a particle size between about 5 and 10 microns.

8. The electrochemical cell according to claim 1, wherein said separator includes woven fabric having high mechanical strength.

9. The electrochemical cell according to claim 1, wherein at least one of the electrodes substrate is made of a flexible metal grid.

10. The electrochemical cell according to claim 1, wherein said substrate is made of a fabric woven from graphite fibers, said graphite fibers being coated with a impermeable metal coating.

11. The electrochemical cell according to claim 1, wherein said metal coating has thickness of about 5 to 15 microns.

12. The electrochemical cell according to claim 1, wherein the cell is a Silver-Zinc rechargeable cell, and wherein the coating on fibers of cathode substrate is made of a material selected from the group consisting of Nickel or Silver and the coating on fibers of anode substrate is made of a material selected from the group consisting of tin, indium, cadmium, and lead.

13. The electrochemical cell according to claim 1, wherein at least one layer of said separator is made of a material that swells within the electrolyte, thereby applying pressure on said electrodes.

14. The electrochemical cell according to claim 1, wherein said separator is made of a material impermeable to ions of said electrode materials.

15. The electrochemical cell according to claim 1, in which at least one layer of the said separator is made of polyethylene-polypropylene film or diaphragm.

16. The electrochemical cell according to claim 1, in which said separator is made of porous material capable of impeding growth of dendrites during functioning of the cell.

17. The electrochemical cell according to claim 1, wherein said separators are impermeable to ions of the active materials.
